(19) United States
(12) Patent Application Publication
(10) Pub. No.: US 2016/0085557 A1
(43) Pub. Date: Mar. 24, 2016

(54) PROCESSOR AND PROCESSING METHOD OF VECTOR INSTRUCTION

(71) Applicant: Socionext Inc., Yokohama-shi (JP)

(72) Inventors: Kenta Suzuki, Ninomiya (JP); Hiroshi Hatano, Kawasaki (JP); Koichi Suzuki, Yokohama (JP); Takashi Nishikawa, Yokohama (JP)

(73) Assignee: Socionext Inc., Yokohama-shi (JP)

(21) Appl. No.: 14/840,413

(22) Filed: Aug. 31, 2015

(30) Foreign Application Priority Data
Sep. 24, 2014 (JP) 2014-194305

(51) Int. Cl. G06F 9/38; G06F 9/30

(52) U.S. Cl. CPC G06F 9/3851; G06F 9/30036; G06F 9/30043

(57) ABSTRACT

A processor includes: a plurality of pipelines including a first pipeline and a second pipeline and configured to pipeline-process vector instructions including load instructions with respect to a memory, and when an instruction issuance controller configured to decode a vector instruction read out from an instruction memory and issue instructions to the pipelines issues a first load instruction with respect to a first region of a memory to the first pipeline and a second load instruction with respect to the first region of the memory is being processed in the second pipeline, a processing order in the first load instruction in the first pipeline is changed on the basis of an offset value determined according to a number of cycles that have been processed already in the second load instruction so that an access address of the first load instruction matches an access address of the second load instruction.

### CROSS-REFERENCE TO RELATED APPLICATION

This application is based upon and claims the benefit of priority of the prior Japanese Patent Application No. 2014-194305, filed on Sep. 24, 2014, the entire contents of which are incorporated herein by reference.

### FIELD

The embodiments discussed herein are directed to a processor and a processing method of a vector instruction.

### BACKGROUND

A vector processor (vector processing device) includes an array-type register file (vector register) and performs arithmetic processing, load/store processing, and the like according to vector instructions on array-type data. The size of the array data, namely, the number of array elements is specified by a vector length (VL). That is, the vector processor can collectively process arithmetic operation and the like on data whose number is specified by the vector length (VL) by a single vector instruction.

FIG. 12 is a view illustrating a processing example of vector instructions in the vector processor. FIG. 12 illustrates a processing example in the vector processor that includes four execution pipelines, which are pipelines A, B, C, and D. Each of execution pipelines is a five-stage pipeline configuration of an instruction fetch stage IF, an instruction decode stage ID, an arithmetic operation execution stage EX, a memory access stage MEM, and a write-back stage WB.

In the instruction fetch stage IF, an instruction (vector instruction) is read out (fetched) from an instruction memory in which instruction sequences are stored. In the instruction decode stage ID, the instruction read out in the instruction fetch stage IF is decoded and the instruction is supplied to a sequencer in the execution pipeline. The sequencer performs control of the pipeline according to the supplied instruction. The sequencer calculates indexes of a source register and a destination register based on an internal counter value, for example, and reads out data (operands).

In the arithmetic operation execution stage EX, arithmetic processing specified by the instruction is executed and an arithmetic result is written in various registers. When the instruction is a load instruction or a store instruction with respect to a memory, an address calculation is performed by using the operand (a base address) read out in the instruction decode stage ID and the internal counter value, and memory access to a calculated address is executed. In the memory access stage MEM, when the instruction is a load instruction with respect to the memory, load data corresponding to the memory access executed in the arithmetic operation execution stage EX are read out. In the write-back stage WB, the load data read out in the memory access stage MEM are written in the various registers.

That is, when the vector instruction is an arithmetic operation instruction (for example, addition instruction vadd), in the instruction fetch stage IF, an arithmetic operation instruction is read out from the instruction memory, and in the instruction decode stage ID, the arithmetic operation instruction is decoded to be input to the vacant execution pipeline among the pipelines A to D. The pipeline reads out a data element from the vector register in the instruction decode stage ID. Then, in the arithmetic operation execution stage EX, an arithmetic operation is performed on the read data element and a result of the arithmetic operation is written in the vector register. In the arithmetic operation execution stage EX, data of the same index and data of the same index are arithmetically operated and a result of the arithmetic operation is stored in a field of the corresponding index in the destination register.

For example, when the vector instruction is a load instruction (for example, load instruction vld) with respect to the memory, in the instruction fetch stage IF, a load instruction is read out from the instruction memory, and in the instruction decode stage ID, the load instruction is decoded to be input to the vacant execution pipeline among the pipelines A to D. The pipeline calculates a memory address to which the pipeline gains access in the arithmetic operation execution stage EX and performs memory access to the calculated memory address. The memory address is obtained by adding an address offset (counter value of the sequencer×memory access size) to the base address specified by the operand read out in the instruction decode stage ID. Then, in the memory access stage MEM, a data element is read out from a region of the memory corresponding to the memory address, and in the write-back stage WB, the read data element is written in the vector register.

The processing when vector instructions A, B, C, D, E, F, G, and H, each of which is executed for eight cycles, are executed in order in the vector processor whose number of vector instructions issuable for one cycle is one, for example, is illustrated like the example illustrated in FIG. 12. In the example illustrated in FIG. 12, it is assumed that there are no dependency relations among the instructions A to H. Regarding the notation of “(alphabetical character)-(numeric character)” in FIG. 12, the alphabetical character represents an instruction being executed, and the numeric character represents a counter value of a sequencer.

First, the vector instruction A is read out from the instruction memory and is supplied to the pipeline A to be processed. In the following cycle, the vector instruction B is read out from the instruction memory and is supplied to the pipeline B to be processed. In the following cycle, the vector instruction C is read out from the instruction memory and is supplied to the pipeline C to be processed, and in the following cycle, the vector instruction D is read out from the instruction memory and is supplied to the pipeline D to be processed. When the execution pipelines A to D are occupied, execution of the following vector instruction is made to wait until the execution pipeline becomes vacant.

In the example illustrated in FIG. 12, when the processing of the vector instruction A in the pipeline A is finished (processing of A-7 is finished), the following vector instruction E is read out from the instruction memory and is supplied to the pipeline A to be processed. Similarly, when the processing of the vector instruction B in the pipeline B is finished (processing of B-7 is finished), the following vector instruction F is read out from the instruction memory and is supplied to the pipeline B to be processed. Further, similarly, when the processing of the vector instruction C in the pipeline C is finished, the following vector instruction G is read out from the instruction memory and is supplied to the pipeline C to be processed. When the processing of the vector instruction D in the pipeline D is finished, the following vector instruction H is read out from the instruction memory and is supplied to the pipeline D to be processed.

There is a processor system in which parallel processing is performed in a manner to separate access processing to a resource and other processings and the access processing to the resource is made to progress in a preceding manner (see, for example, Patent Document 1). In Patent Document 1, there is proposed a technique in which in terms of an execution order, a load instruction and a store instruction are replaced with each other, to thereby achieve high-efficiency of a CPU unit included in the processor system. There is proposed a technique in which in an information processor with a plurality of processors sharing a shared resource, addresses of a read access received from the plurality of processors are compared, data of the matched addresses are read from the shared resource, and the read data are output to the plurality of processors that have output the addresses at the same timing (see, for example, Patent Document 2)

[Patent Document 1] Japanese Laid-open Patent Publication No. 07-191945

[Patent Document 2] Japanese Laid-open Patent Publication No. 2011-221569

There is a case that in the vector processor, a load instruction to read data of the same region in a data memory with a long vector length is executed frequently, like pilot signal processing in baseband processing, for example. The pilot signal processing is processing to input a sample signal to a communication signal (communication data) for measuring a property of a transmission path in radio communication and perform correction and the like using it. Since the pilot signal processing is processing to perform correction by reading out the same data repeatedly, memory access to the same memory region occurs repeatedly.

In the example illustrated in FIG. 12, for example, when the vector instruction A and the vector instruction C are a load instruction with respect to the same memory region, the instructions each perform memory access. When the same data are used in a plurality of pipelines as above, memory access to the same memory region is performed repeatedly in the plurality of pipelines, which has caused a waste.

### SUMMARY

An aspect of a processor includes: a plurality of pipelines configured to pipeline-process vector instructions including load instructions with respect to a memory, the plurality of pipelines including a first pipeline and a second pipeline; an instruction issuance controller configured to decode a vector instruction read out from an instruction memory and issue the vector instruction to the pipeline; and a controller configured to control a processing order in the vector instruction in the pipeline. The controller, when the instruction issuance controller issues a first load instruction with respect to a first region of a memory to the first pipeline and a second load instruction with respect to the first region of the memory is being processed in the second pipeline, determines an offset value according to a number of cycles that have been processed already in the second load instruction so that an access address of the first load instruction to the memory matches an access address of the second load instruction to the memory, and changes a processing order in the first load instruction in the first pipeline on the basis of the offset value.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a view illustrating a configuration example of a processor in an embodiment;

FIG. 2 is a view illustrating an example of a vector register in this embodiment;

FIG. 3A and FIG. 3B are views each illustrating an example of a data memory in this embodiment;

FIG. 4 is a view illustrating a configuration example of a processing offset determiner in this embodiment;

FIG. 5 is a flowchart illustrating an operation example of the processing offset determiner in this embodiment;

FIG. 6A and FIG. 6B are flowcharts illustrating an operation example of a sequencer in this embodiment;

FIG. 7 is a flowchart illustrating a processing example in an execution pipeline in this embodiment;

FIG. 8A is a view illustrating an example of vector instructions to be executed in the processor in this embodiment;

FIG. 8B and FIG. 8C are views used for explaining an operation example of the processor in this embodiment;

FIG. 9A is a view illustrating another example of vector instructions to be executed in the processor in this embodiment;

FIG. 9B and FIG. 9C are views used for explaining another operation example of the processor in this embodiment;

FIG. 10 is a view used for explaining another operation example of the processor in this embodiment;

FIG. 11 is a view illustrating an example of a semiconductor integrated circuit including the processor in this embodiment; and

FIG. 12 is a view illustrating a processing example of vector instructions in a vector processor.

### DESCRIPTION OF EMBODIMENTS

Hereinafter, the embodiments will be explained based on the drawings.

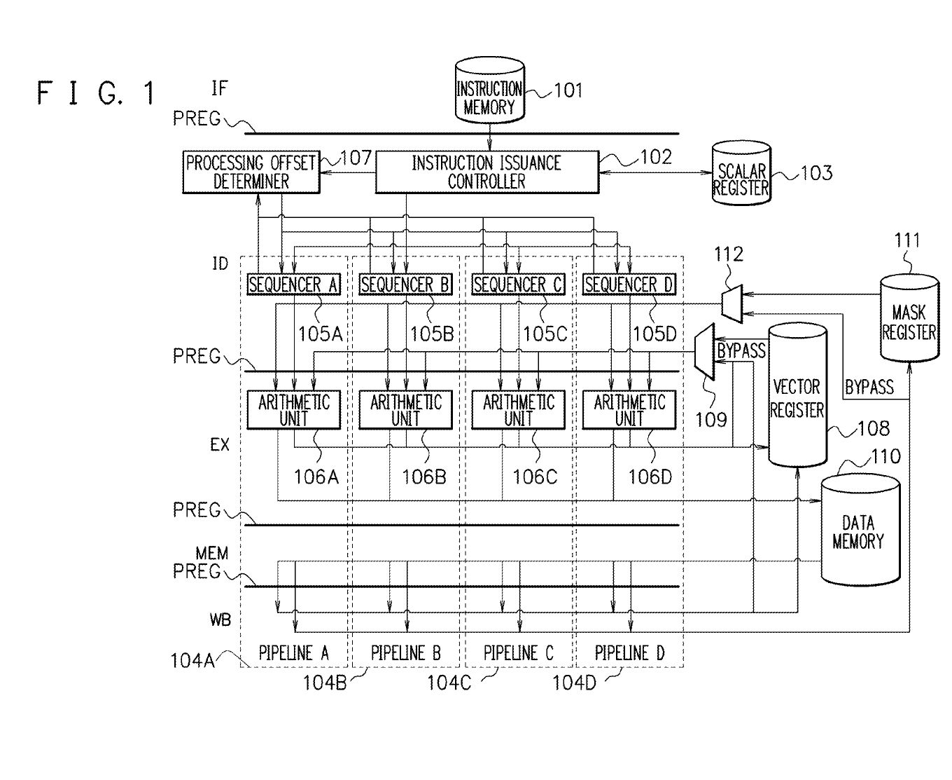

FIG. 1 is a view illustrating a configuration example of a processor in one embodiment. FIG. 1 illustrates a vector processor that includes four execution pipelines 104 (104A to 104D), which are pipelines A, B, C, and D as one example. For example, each of the four execution pipelines 104 is a five-stage pipeline configuration of an instruction fetch stage IF, an instruction decode stage ID, an arithmetic operation execution stage EX, a memory access stage MEM, and a write-back stage WB. In the execution pipelines 104, supply of data and the like from the prior stage to the subsequent stage is performed via a pipeline register PREG.

In the instruction fetch stage IF, an instruction (vector instruction) is read out (fetched) from an instruction memory 101 in which instruction sequences are stored. In the instruction decode stage ID, an instruction issuance controller 102 decodes the vector instruction read out in the instruction fetch stage IF to supply the instruction to a sequencer 105 (105A to 105D) of the pipeline 104 in a vacant state (not in an instruction in-processing state) among the execution pipelines A to D. The sequencer 105 receives a start signal from the instruction issuance controller 102 and performs control of the pipeline according to the instruction. The sequencer 105 calculates indexes of a source register to be a processing object and a destination register where processing results are stored based on an internal counter value, for example, and reads data (operands) of various registers (a scalar register 103, a vector register 108, and a mask register 111).

The vector register 108 stores array data (vector data). The array data stored in the vector register 108 are supplied to the execution pipelines 104 via a selector 109. Incidentally, although not being written in the vector register 108 yet, array data obtained already as a processing result can be supplied to the execution pipelines 104 via the selector 109.

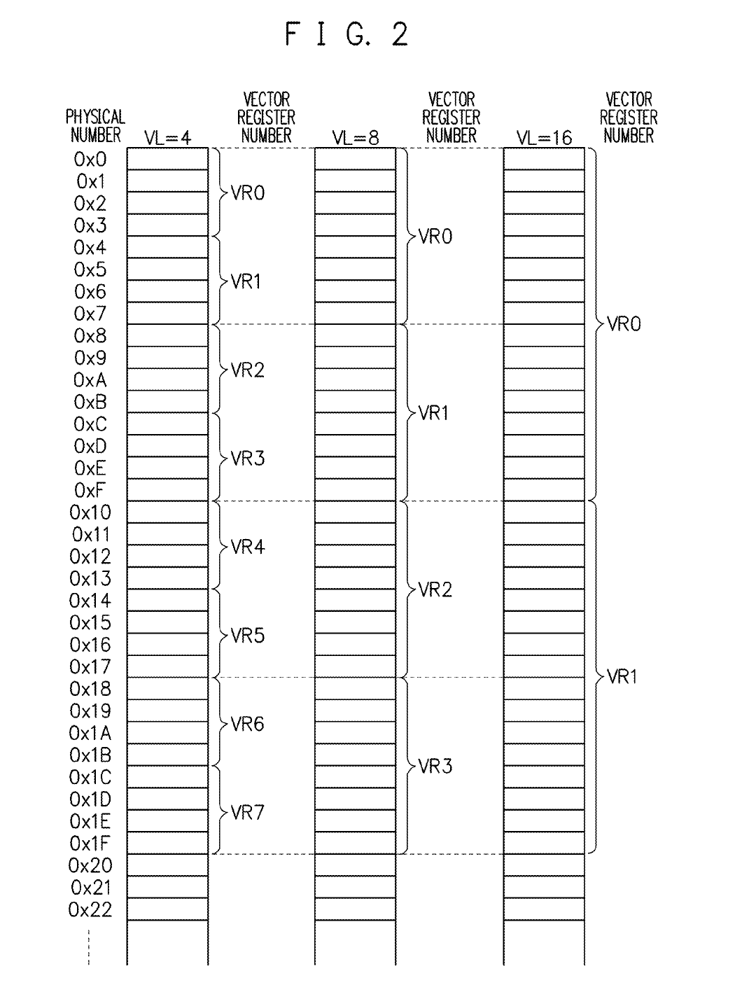

The vector register 108 includes a plurality of registers as illustrated in FIG. 2, for example. The size of the array data, namely, the number of data elements in the array data is specified by a vector length (VL). In other words, the number of available registers is specified by the vector length (VL). When the vector length (VL) is four, four registers correspond to one vector register number (logical register number), for example, registers of physical numbers 0x0 to 0x3 correspond to a vector register number VR0, and registers of physical numbers 0x4 to 0x7 correspond to a vector register number VR1.

When the vector length (VL) is eight, eight registers correspond to one vector register number (logical register number), for example, registers of physical numbers 0x0 to 0x7 correspond to a vector register number VR0, and registers of physical numbers 0x8 to 0xF correspond to a vector register number VR1. When the vector length (VL) is sixteen, sixteen registers correspond to one vector register number (logical register number), for example, registers of physical numbers 0x0 to 0xF correspond to a vector register number VR0, and registers of physical numbers 0x10 to 0x1F correspond to a vector register number VR1.

The scalar register 103 stores scalar data. The mask register 111 stores mask data used for invalidating, when using one part of the array data (vector data) to be processed by a vector instruction, and the like, the other part of the array data. The mask data stored in the mask register 111 are supplied to the execution pipelines 104 via a selector 112. Incidentally, although not being written in the mask register 111 yet, mask data obtained already can be supplied to the execution pipelines 104 via the selector 112.

In the arithmetic operation execution stage EX, arithmetic processing specified by the vector instruction is executed in an arithmetic unit 106 (106A to 106D) and an arithmetic result is written in the various registers. When the vector instruction is a load instruction or a store instruction with respect to a data memory 110, an address calculation is performed by using the operand (a base address) read out in the instruction decode stage ID and the internal counter value. Then, from the calculated address, a bank select signal of a memory bank, to which the execution pipeline gains access, in the data memory 110 is generated and memory access to the data memory 110 is executed.

In the memory access stage MEM, when the vector instruction is a load instruction with respect to the data memory 110, based on the bank select signal generated in the arithmetic operation execution stage EX, load data of the corresponding memory bank of the data memory 110 are read out. In the write-back stage WB, the load data read out in the memory access stage MEM are written in the various registers.

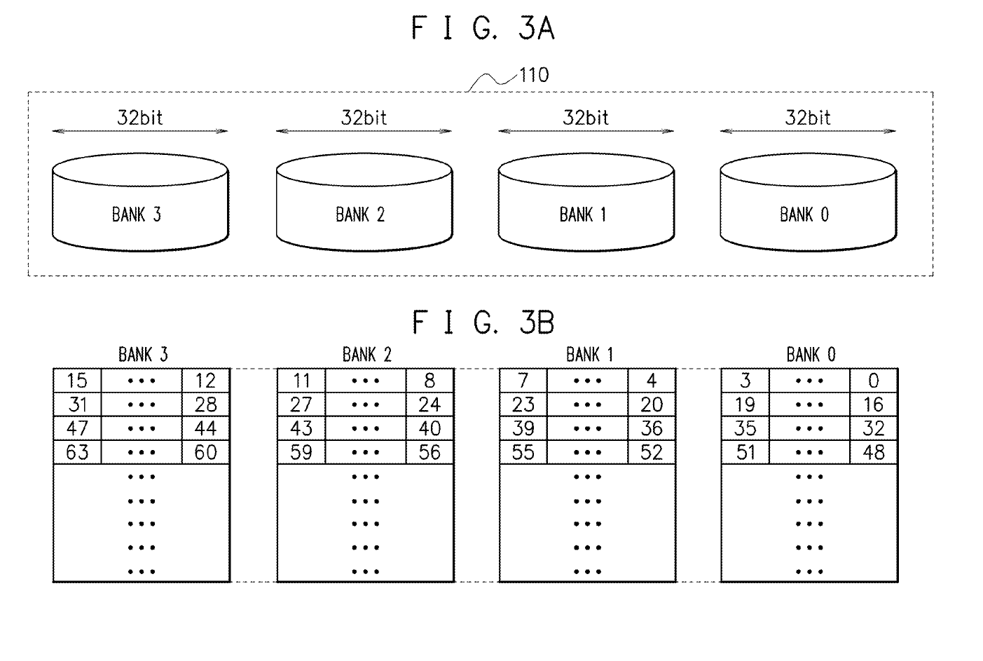

The data memory 110, as illustrated in FIG. 3A, for example, includes a plurality of memory banks. In the example illustrated in FIG. 3A, the data memory 110 includes four memory banks, and each of the memory banks has a 32-bit width. Addresses in the data memory 110 are allocated by a bank interleaving method as illustrated in FIG. 3B. The memory banks in the data memory 110 each include an access port individually, which makes it possible to perform memory access in parallel. The constitution of the data memory 110 illustrated in FIG. 3A and FIG. 3B is one example, and is not limited to this.

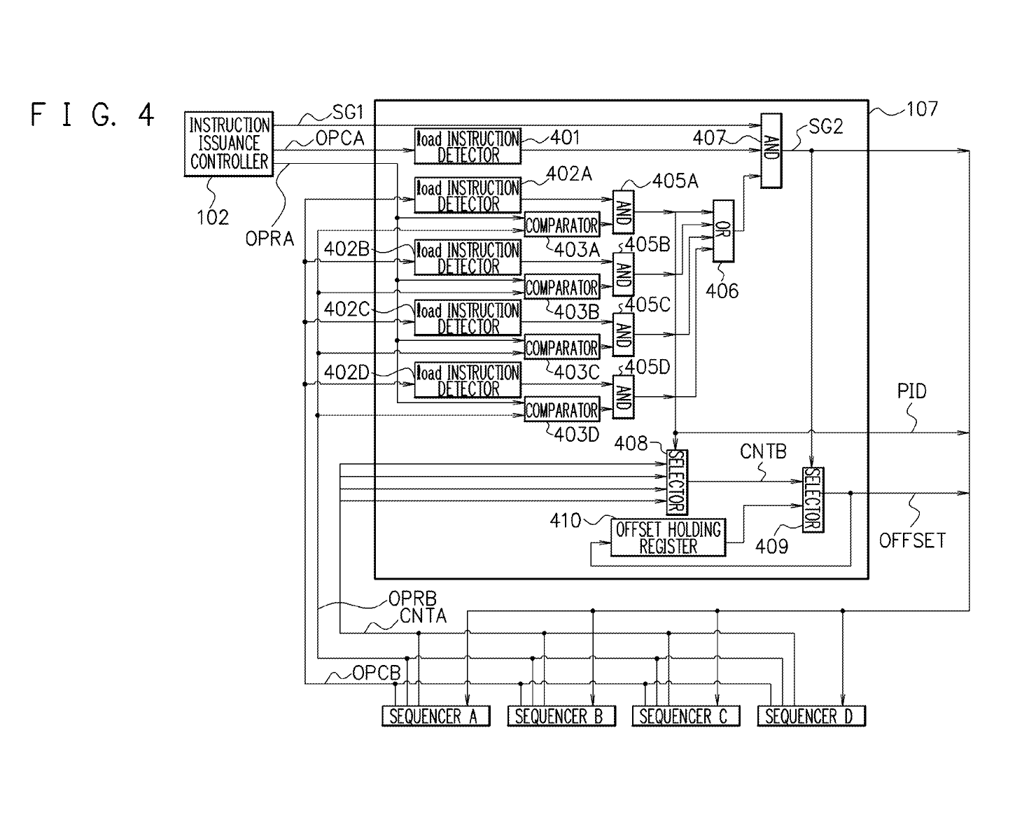

FIG. 4 is a view illustrating a configuration example of a processing offset determiner 107 illustrated in FIG. 1. The processing offset determiner 107 includes: a load instruction detector 401; load instruction detectors 402 (402A to 402D); comparators 403 (403A to 403D); logical product operation circuits (AND circuits) 405 (405A to 405D); a logical sum operation circuit (OR circuit) 406; an AND circuit 407; selectors 408 and 409; and an offset holding register 410.

From the instruction issuance controller 102, dependency relation detection information SG1 indicating whether or not there is a dependency relation between an instruction to be issued (succeeding instruction) and an instruction of which processing is in execution (preceding instruction), operation code information OPCA of an instruction to be issued, and a source operand OPRA of the instruction to be issued are input to the processing offset determiner 107. In this embodiment, the dependency relation detection information SG1 is “1” (true) when there is no dependency relation between a preceding instruction and a succeeding instruction. And the dependency relation detection information SG1 is “0” (false) when there is a dependency relation between a preceding instruction and a succeeding instruction.

Further, operation code information OPCB of an instruction being processed in the execution pipeline (preceding instruction), a source operand OPRB of the instruction, and a current sequencer counter value CNTA of the execution pipeline are input to the processing offset determiner 107 from the sequencers A to D of the execution pipelines. Here, when the instruction is a load instruction, the source operands OPRA and OPRB of the instructions indicate the base addresses for memory access.

The load instruction detector 401 detects whether or not the instruction to be issued is a load instruction based on the operation code information OPCA of the instruction to be issued, input from the instruction issuance controller 102. The load instruction detectors 402A to 402D each detect whether or not the instruction being processed currently (preceding instruction) is a load instruction based on the operation code information OPCB of the instruction being processed currently, input from the corresponding sequencers A to D of the execution pipelines. In this embodiment, outputs of the load instruction detector 401 and 402A to 402D become “1” (true) when the instruction is a load instruction, and the outputs become “0” (false) when the instruction is not a load instruction.

The comparators 403A to 403D each compare the source operand OPRA of the instruction to be issued input from the instruction issuance controller 102 and the source operand OPRB of the instruction being processed currently input from the corresponding sequencers A to D of the execution pipelines. That is, the comparators 403A to 403D each detect whether or not the base addresses for memory access are matched when the instruction to be issued and the instruction being processed currently both are a load instruction. In this embodiment, outputs of the comparators 403A to 403D become “1” (true) when the source operands OPRA and OPRB of the instructions are matched, and the outputs become “0” (false) when the source operands OPRA and OPRB of the instructions are different.

The AND circuits 405A to 405D perform logical product operation on the outputs of the corresponding load instruction detectors 402A to 402D and the corresponding comparators 403A to 403D to output operation results respectively. The AND circuits 405A to 405D output “1” (true) in case that the instruction being processed currently in the corresponding execution pipeline is a load instruction and when the source operand OPRA of the instruction to be issued and the source operand OPRB of the instruction being processed currently in the corresponding execution pipeline are matched (the base addresses for memory access are matched), and the AND circuits 405A to 405D output “0” (false) in the case other than the above. Outputs of the AND circuits 405A to 405D are, as pipeline ID information PID (4-bit information in this example), supplied to the selector 408 and are supplied to the sequencers A to D of the execution pipelines.

The OR circuit 406 performs logical sum operation on the outputs of the AND circuits 405A to 405D to output an operation result. Accordingly, when there is a load instruction with the source operand OPRB of the instruction matching the source operand OPRA of the instruction to be issued among the instructions being processed currently in the execution pipelines, an output of the OR circuit 406 becomes “1” (true).

The AND circuit 407 performs logical product operation on the dependency relation detection information SG1 input from the instruction issuance controller 102, an output of the load instruction detector 401, and an output of the OR circuit 406 to output an operation result. That is, the AND circuit 407 outputs “1” (true) when the instruction to be issued is a load instruction having no dependency relations with the instructions being processed currently and there is a load instruction with the matched base address for memory access (that performs memory access to the same memory region) among the instructions being processed currently in the execution pipelines. An output of the AND circuit 407 is, as load instruction matching detection information SG2, supplied to the selector 409 and is supplied to the sequencers A to D of the execution pipelines.

The selector 408 selectively outputs the current sequencer counter value CNTA input from the sequencers A to D of the execution pipelines according to the outputs of the AND circuits 405A to 405D (pipeline ID information PID). The selector 408 selects the current sequencer count value CNTA of the sequencers A to D of the execution pipelines with the outputs of the AND circuits 405A to 405D being “1” to output it.

The selector 409 selects either an output CNTB of the selector 408 or an output of the offset holding register 410 according to the load instruction matching detection information SG2 output from the AND circuit 407 to output the selected resultant. The selector 409 outputs the output CNTB of the selector 408 when the load instruction matching detection information SG2 is “1,” and outputs the output of the offset holding register 410 when the load instruction matching detection information SG2 is “0.” An output of the selector 409 is, as a processing offset value OFFSET, held in the offset holding register 410 and is supplied to the sequencers A to D of the execution pipelines. An initial value of the offset holding register 410 is 0.

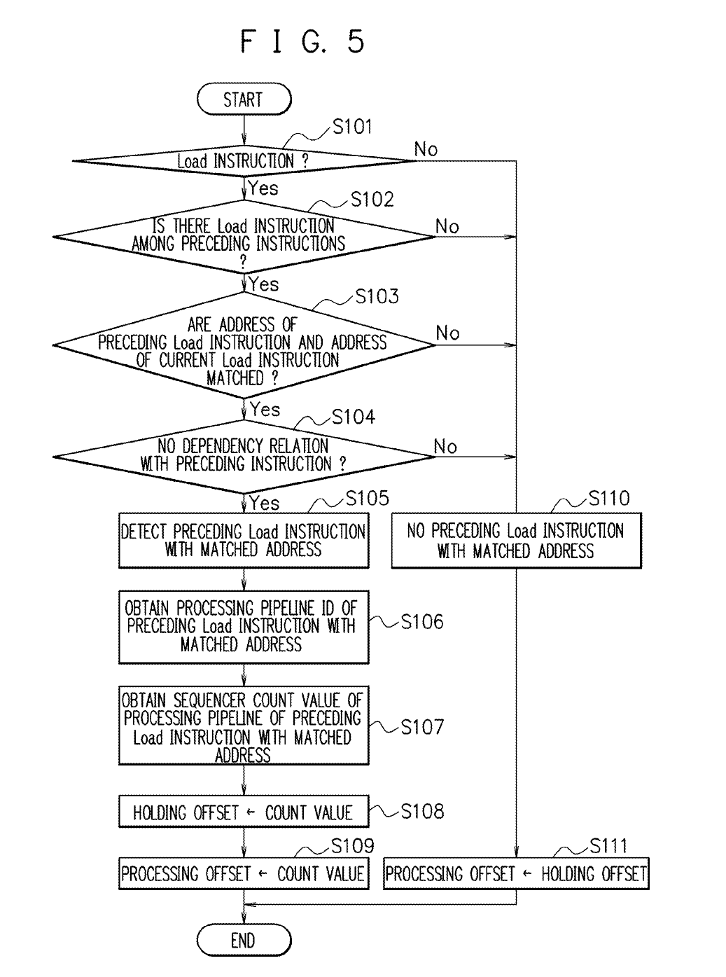

FIG. 5 is a flowchart illustrating an operation example of the processing offset determiner 107 in this embodiment. FIG. 5 illustrates the flow of processing to be performed for one cycle.

At step S101, the processing offset determiner 107 detects whether or not the instruction to be issued is a load instruction based on the operation code information of the instruction to be issued, input from the instruction issuance controller 102. When the instruction to be issued is a load instruction (Yes at step S101), at step S102, the processing offset determiner 107 detects whether or not there is a load instruction among the instructions being processed currently (preceding instructions) based on the operation code information of the instructions being processed currently, input from the sequencers A to D of the execution pipelines 104.

When there is a load instruction among the instructions being processed currently (Yes at step S102), at step S103, the processing offset determiner 107 detects whether or not the source operand of the load instruction to be issued input from the instruction issuance controller 102 and the source operand of the load instruction being processed currently input from the sequencers A to D of the execution pipelines 104 are the same. That is, the processing offset determiner 107 detects whether or not the base address for memory access in the load instruction to be issued and the base address for memory access in the load instruction being processed currently are matched.

When the source operands of the instructions are the same, namely the base addresses for memory access in the load instructions are matched, at step S104, the processing offset determiner 107 detects whether or not there is no dependency relation between the load instruction to be issued and each of the instructions being processed currently based on the dependency relation detection information input from the instruction issuance controller 102. In the case when there is a dependency relation between the load instruction to be issued and each of the instructions being processed currently, when rearrangement of a processing order of the load instruction to be issued is performed as will be described later, a stall occurs, and thus the dependency relation detection is performed in order that processing is performed in the normal order.

When there is no dependency relation between the load instruction to be issued and each of the instructions being processed currently (Yes at step S104), namely when the instruction to be issued is a load instruction and there is a load instruction with the matched base address for memory access among the instructions being processed currently and there is no dependency relation between the load instruction to be issued and each of the instructions being processed currently, the operation proceeds to step S105. At step S105, the processing offset determiner 107 outputs the load instruction matching detection information indicating that there is a load instruction being processed currently with the matched base address for memory access.

Next, at step S106, the processing offset determiner 107 obtains the pipeline ID information indicating the execution pipeline that is currently processing the load instruction matching the load instruction to be issued with the base address for memory access to output it to the sequencers of the execution pipelines 104. Subsequently, at step S107, the processing offset determiner 107 obtains a count value of the sequencer of the execution pipeline 104 that is currently processing the load instruction matching the load instruction to be issued with the base address for memory access.

At step S108, the processing offset determiner 107 updates the value of the offset holding register to the count value obtained at step S107. At step S109, the processing offset determiner 107 outputs the count value obtained at step S107 to the sequencers of the execution pipelines 104 as the processing offset value. Thereby, in the instruction to be issued, rearrangement of the processing order in the instruction is performed as will be described later.

When the instruction to be issued is not a load instruction, or there is no load instruction with the matched base address for memory access among the instructions being processed currently, or there is a dependency relation between the load instruction to be issued and each of the instructions being processed currently (No at any one of steps S101 to S104), the operation proceeds to step S110. At step S110, the processing offset determiner 107 judges that there is no load instruction being processed currently with the matched base address for memory access, and outputs the load instruction matching detection information indicating that effect. Next, at step S111, the processing offset determiner 107 outputs the offset value held in the offset holding register to the sequencers of the execution pipelines 104 as the processing offset value.

In this manner, by the processing in the processing offset determiner 107, the count value of the sequencer of the execution pipeline 104 that is currently processing the load instruction matching the load instruction to be issued with the base address for memory access is set to the processing offset value of the load instruction to be issued, and thereby it is possible to match a memory access address of the load instruction to be issued and a memory access address of the preceding load instruction. Incidentally, the order of performing the processings of steps S101 to S104 is not limited to the one illustrated in FIG. 5 as an example, and the order of performing the processings of steps S101 to S104 is arbitrary. Further, the processing in the processing offset determiner 107 illustrated in FIG. 5 as an example is not limited to the execution by the processing offset determiner 107 with a hardware configuration illustrated in FIG. 4, and may also be executed by software processing according to need.

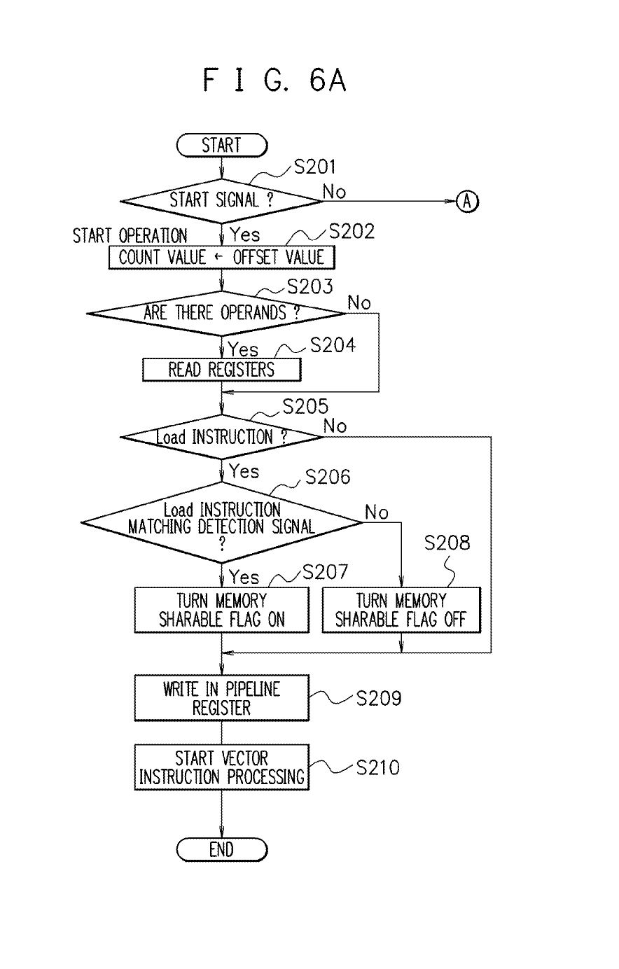

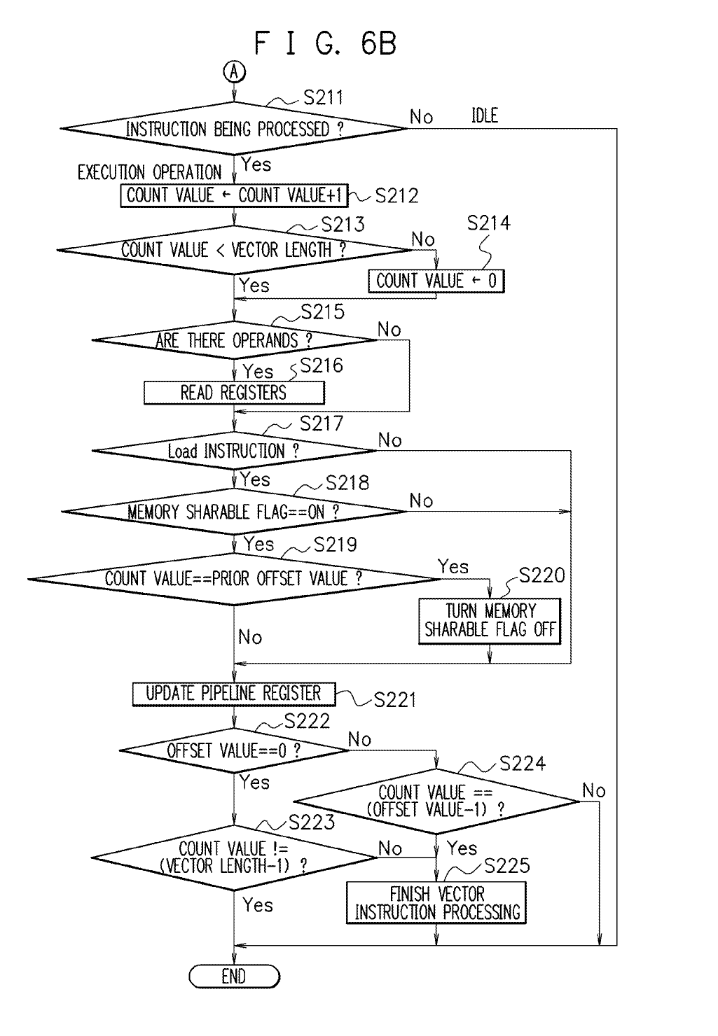

FIG. 6A and FIG. 6B are flowcharts illustrating an operation example of the sequencer 105 in this embodiment. FIG. 6A and FIG. 6B illustrate the flow of processing to be performed for one cycle.

As illustrated in FIG. 6A, at step S201, the sequencer 105 confirms whether or not the start signal has been input thereto from the instruction issuance controller 102. When the start signal has been input from the instruction issuance controller 102 (Yes at step S201), at step S202, the sequencer 105 initializes the count value of the counter for vector instruction execution control to the processing offset value input from the processing offset determiner 107. Note that the prior processing offset value (processing offset value before initialization) is used in processing to be described later, and thus the prior processing offset value is held in the sequencer 105.

Next, at step S203, the sequencer 105 judges whether to need operand due to the instruction. When the operand is needed (Yes at step S203), at step S204, the sequencer 105 generates an index of the source register from the count value, and based on the generated index of the source register, reads the values of the various registers (the scalar register 103, the vector register 108, and the mask register 111).

Next, at step S205, the sequencer 105 judges whether or not the instruction to execute is a load instruction. When the instruction to execute is a load instruction (Yes at step S205), at step S206, the sequencer 105 confirms whether or not a load instruction matching detection signal has been input thereto from the processing offset determiner 107.

When the load instruction matching detection signal has been input from the processing offset determiner 107 (Yes at step S206), at step S207, the sequencer 105 turns a memory sharable flag on. On the other hand, when the load instruction matching detection signal has not been input from the processing offset determiner 107 (No at step S206), at step S208, the sequencer 105 turns the memory sharable flag off. Here, when the memory sharable flag is on, the sequencer 105 shares load data of the preceding load instruction with the matched base address for memory access, and when the memory sharable flag is off, the sequencer 105 performs normal load instruction processing.

At step S209, the sequencer 105 writes the operand read out at step S204, the memory sharable flag set at step S207 or S208, and the pipeline ID information input from the processing offset determiner 107 in the pipeline register PREG. Further, the sequencer 105 writes a control signal generated based on the count value (a bank enable signal or the like related to memory access in the case of a load instruction or a store instruction, for example) and the index of the destination register in the pipeline register PREG.

At step S210, the sequencer 105 starts processing of the vector instruction (move to an instruction in-processing state). Then, according to the values of the pipeline register PREG, processings in the arithmetic operation execution stage EX, the memory access stage MEM, and the write-back stage WB are performed.

When the start signal has not been input from the instruction issuance controller 102 at step S201 (No at step S201), at step S211 illustrated in FIG. 6B, the sequencer 105 confirms whether or not the instruction is being processed in the execution pipeline (it is the instruction in-processing state). When the instruction is being processed in the execution pipeline (it is the instruction in-processing state), at step S212, the sequencer 105 increments the count value of the counter for vector instruction execution control by one. Next, at step S213, the sequencer 105 judges whether or not the count value is less than the vector length, and when the count value is equal to or more than the vector length, the sequencer 105 resets the count value to 0 (step S214).

Next, at step S215, the sequencer 105 judges whether to need operand due to the instruction. When the operand is needed (Yes at step S215), at step S216, the sequencer 105 generates an index of the source register from the count value, and based on the generated index of the source register, reads out the values of the various registers (the scalar register 103, the vector register 108, and the mask register 111).

Next, at step S217, the sequencer 105 judges whether or not the instruction being processed is a load instruction. When the instruction being processed is a load instruction (Yes at step S217), at step S218, the sequencer 105 judges whether or not the memory sharable flag is on.

When the memory sharable flag is on (Yes at step S218), at step S219, the sequencer 105 compares the current count value and the prior offset value held at step S202. As a result of the comparison, when the current count value and the prior offset value are equal to each other (Yes at step S219), the processing of the preceding load instruction with the matched base address for memory access is finished (processing of part, of the load instruction being processed, overlapping the memory access is finished), so that at step S220, the sequencer 105 turns the memory sharable flag off.

Next, at step S221, the sequencer 105 writes the operand read out at step S216, the memory sharable flag, and the pipeline ID information input from the processing offset determiner 107 in the pipeline register PREG. Further, the sequencer 105 writes a control signal generated based on the count value and the index of the destination register in the pipeline register PREG. Then, according to the updated value of the pipeline register PREG, processings in the arithmetic operation execution stage EX, the memory access stage MEM, and the write-back stage WB are performed.

At step S222, the sequencer 105 confirms whether or not the processing offset value input from the processing offset determiner 107 is 0. When the processing offset value input from the processing offset determiner 107 is 0 (Yes at step S222), at step S223, the sequencer 105 judges whether or not the current count value is (the vector length−1). As a result of the judgment, when the current count value is (the vector length−1), the sequencer 105 finishes the processing of the vector instruction (moves to an idle state) (step S225).

When the processing offset value input from the processing offset determiner 107 is not 0 (No at step S222), at step S224, the sequencer 105 judges whether or not the current count value is (the processing offset value−1). As a result of the judgment, when the current count value is (the processing offset value−1), the sequencer 105 finishes the processing of the vector instruction (moves to an idle state) (step S225).

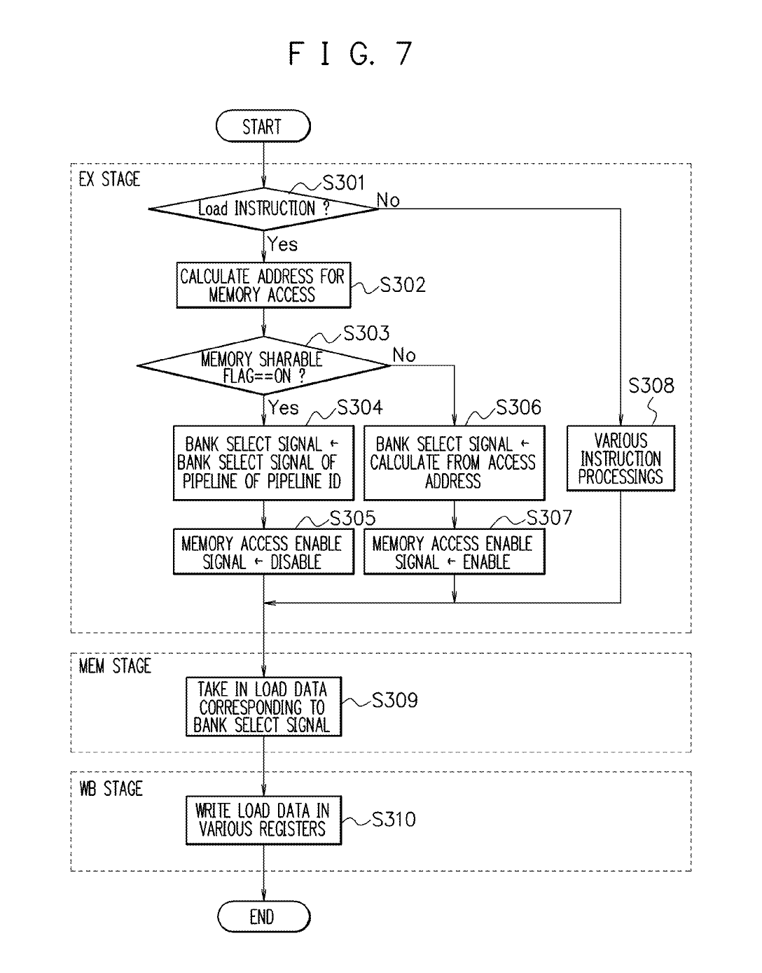

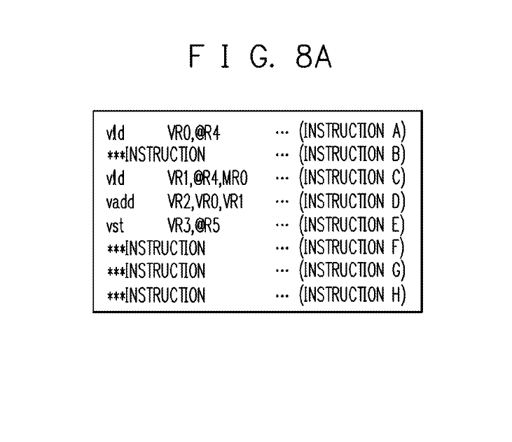

FIG. 7 is a flowchart illustrating a processing example of the execution pipeline 104 in this embodiment. FIG. 7 illustrates processings of the arithmetic operation execution stage EX, the memory access stage MEM, and the write-back stage WB in the execution pipeline 104.

In the arithmetic operation execution stage EX, at step S301, it is determined whether or not the instruction is a load instruction. When the instruction is a load instruction (Yes at step S301), at step S302, an address for memory access is calculated based on the source operand (base address) of the instruction and the count value. The address for memory access is calculated by adding (count value of the sequencer×memory access size) to the base address specified by the operand. As a result of the determination at step S301, when the instruction is not a load instruction (No at step S301), at step S308, processing according to the instruction is performed.

Next, at step S303, it is determined whether or not the memory sharable flag generated in the sequencer 105 is on. When the memory sharable flag is on (Yes at step S303), load data are shared with the preceding load instruction with the matched base address for memory access, so that at step S304, the bank select signal of the pipeline 104 indicated by the pipeline ID information generated in the processing offset determiner 107 is set to a bank select signal of the own pipeline. Then, at step S305, a memory access enable signal of the own pipeline is made disabled to set so as not to perform memory access in the own pipeline.

As a result of the determination at step S303, when the memory sharable flag is off (No at step S303), normal load instruction processing is performed, so that at step S306, a bank select signal of the own pipeline according to the address calculated at step S302 is set. Then, at step S307, the memory access enable signal of the own pipeline is made enabled to set so as to perform memory access in the own pipeline.

In the memory access stage MEM, at step S309, regardless of whether the memory sharable flag is on or off, load data from the data memory 110 are taken in based on the bank select signal. Subsequently, in the write-back stage WB, at step S310, the load data taken in in the memory access stage MEM are written in the various registers.

According to this embodiment, when the load instruction to perform memory access to the same region as the load instruction to be issued is being processed in the execution pipeline, the count value of the sequencer of the execution pipeline 104 that is currently processing the load instruction is set to the processing offset value of the load instruction to be issued, and thereby the memory access address of the load instruction to be issued and the memory access address of the preceding load instruction can be matched. Then, as for the load instruction to be issued, the memory access by the own pipeline is not performed, and data from the data memory 110 obtained by the memory access of the preceding load instruction by the different pipeline are taken in as load data. Thereby, when the same data are used in a plurality of pipelines, repetition of memory access to the same data can be eliminated to decrease the number of times of memory access, resulting in that it is possible to improve memory access efficiency and decrease power consumption.

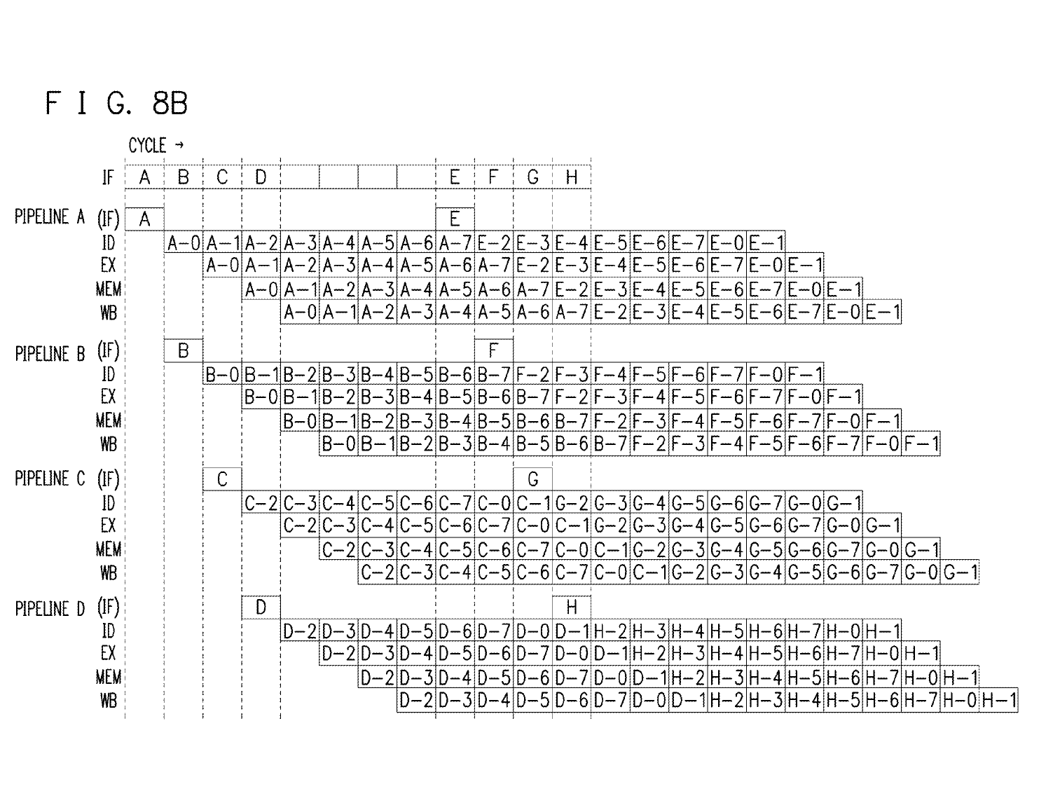

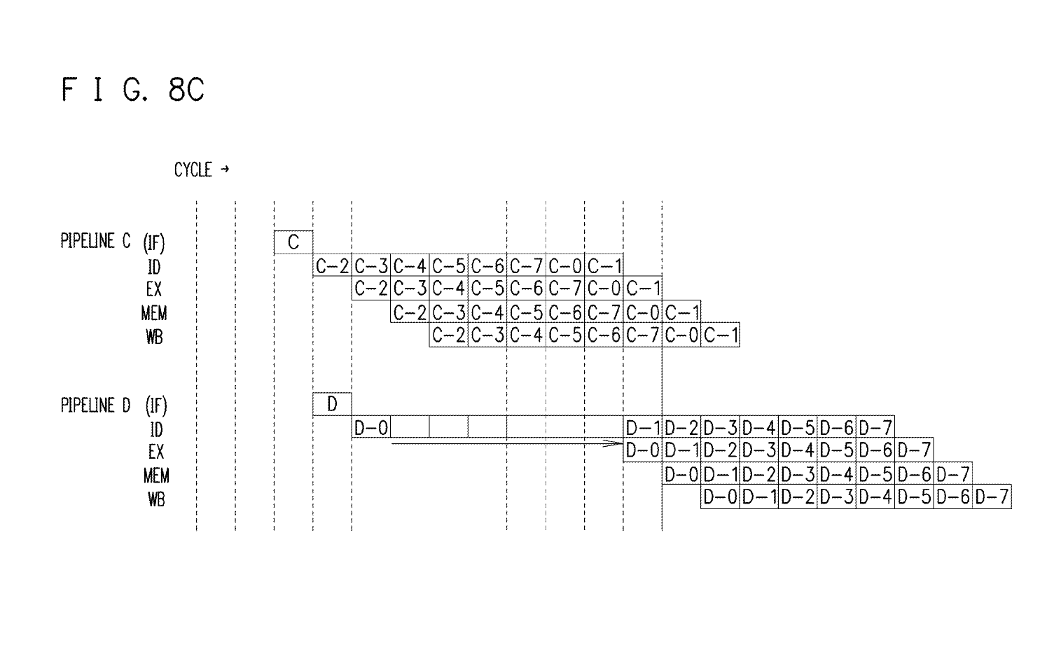

For example, it is assumed that a vector instruction A to a vector instruction H illustrated in FIG. 8A, each of which is executed for eight cycles, are executed. At this time, a load instruction of the vector instruction A and a load instruction of the vector instruction C are matched with “@R4” as a source operand. That is, the load instruction of the vector instruction A and the load instruction of the vector instruction C each perform memory access to the same region of the data memory 110.

In this case, according to this embodiment, as illustrated in FIG. 8B, when processing of the succeeding load instruction (vector instruction C) is started in the pipeline C, “2” being the current count value of the sequencer of the pipeline A that is processing the preceding load instruction (vector instruction A) is set to the count value of the sequencer of the pipeline C as the processing offset value. Thereby, when the count value of the sequencer of the pipeline C is 2 to 7, the memory access by the pipeline C is not performed and data obtained by the memory access by the pipeline A are taken in as load data, resulting in that it is possible to eliminate repetition of memory access to decrease the number of times of memory access.

Here, as illustrated in FIG. 8A, a destination register of the vector instruction C is VR1 and a source register of the vector instruction D is VR1, so that the vector instruction C and the vector instruction D have a dependency relation. Therefore, when the processing offset value is set to the count value of the sequencer of the pipeline only in the case of the vector instruction C, as illustrated in FIG. 8C, a pipeline stall occurs (RAW hazard). Then, in this embodiment, also in the case of the vector instructions D to H after the vector instruction C, the processing offset value is set to the count value of the sequencer of the pipeline, thereby making it possible to perform processing without making a stall occur as illustrated in FIG. 8B.

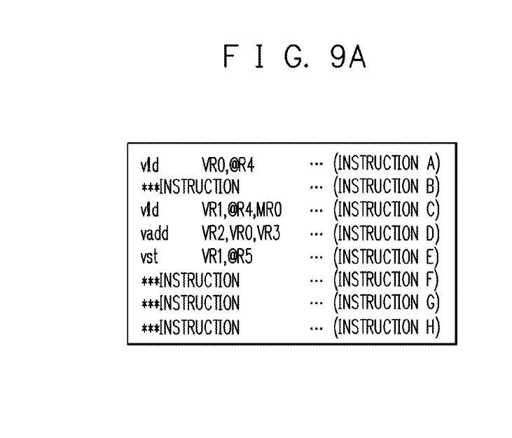

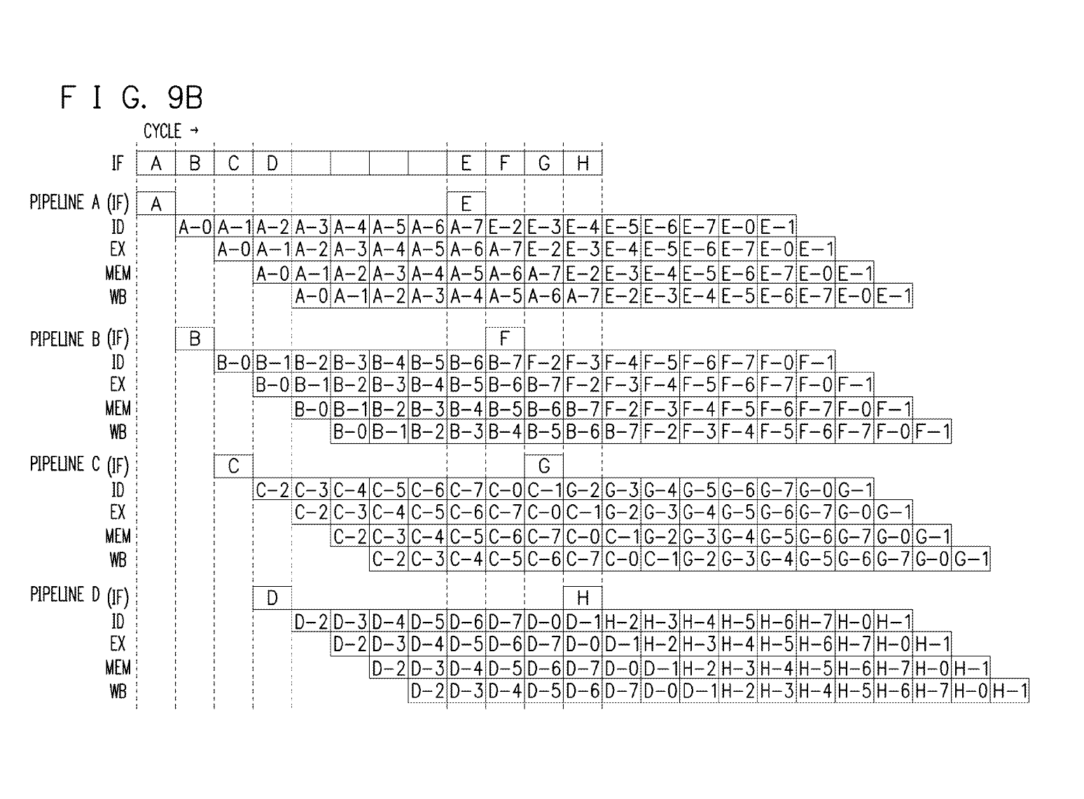

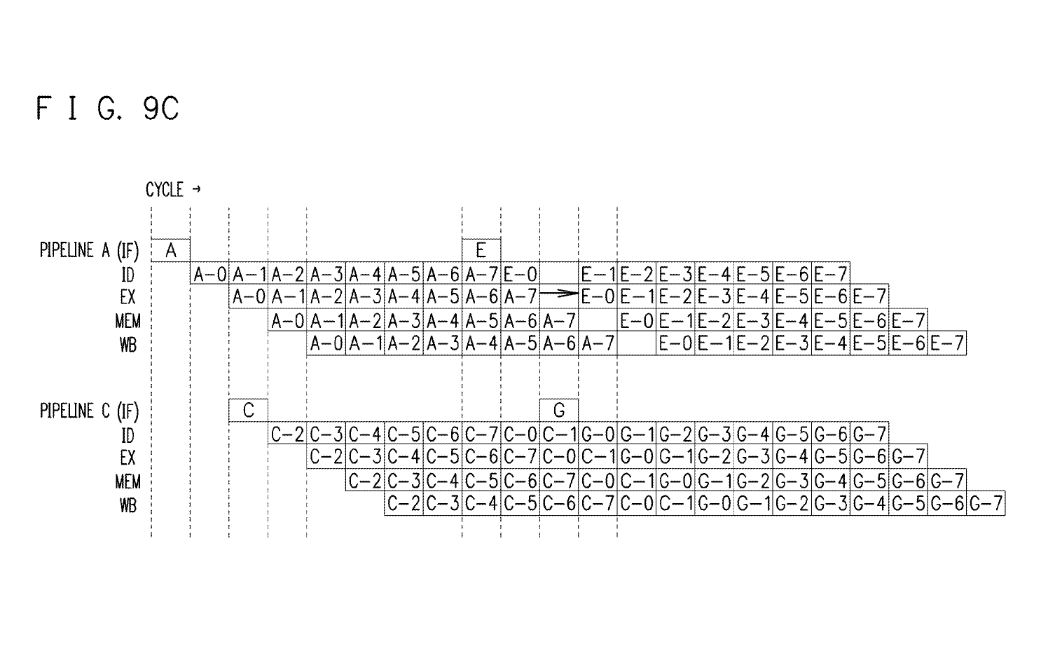

For example, it is assumed that a vector instruction A to a vector instruction H illustrated in FIG. 9A, each of which is executed for eight cycles, are executed. At this time, a load instruction of the vector instruction A and a load instruction of the vector instruction C are matched with “@R4” as a source operand. That is, the load instruction of the vector instruction A and the load instruction of the vector instruction C perform memory access to the same region of the data memory 110.

In this case, according to this embodiment, similarly to the example illustrated in FIG. 8B, as illustrated in FIG. 9B, when processing of the succeeding load instruction (vector instruction C) is started in the pipeline C, “2” being the current count value of the sequencer of the pipeline A that is processing the preceding load instruction (vector instruction A) is set to the count value of the sequencer of the pipeline C as the processing offset value. Thereby, when the count value of the sequencer of the pipeline C is 2 to 7, the memory access by the pipeline C is not performed and data obtained by the memory access by the pipeline A are taken in as load data, resulting in that it is possible to eliminate repetition of memory access to decrease the number of times of memory access.

Here, as illustrated in FIG. 9A, a destination register of the vector instruction C is VR1 and a source register of the vector instruction E is VR1, so that the vector instruction C and the vector instruction E have a dependency relation. Therefore, when the processing offset value is set to the count value of the sequencer of the pipeline only in the case of the vector instruction C, as illustrated in FIG. 9C, a pipeline stall occurs (RAW hazard). Then, in this embodiment, also in the case of the vector instructions D to H after the vector instruction C, the processing offset value is set to the count value of the sequencer of the pipeline, thereby making it possible to perform processing without making a stall occur as illustrated in FIG. 9B.

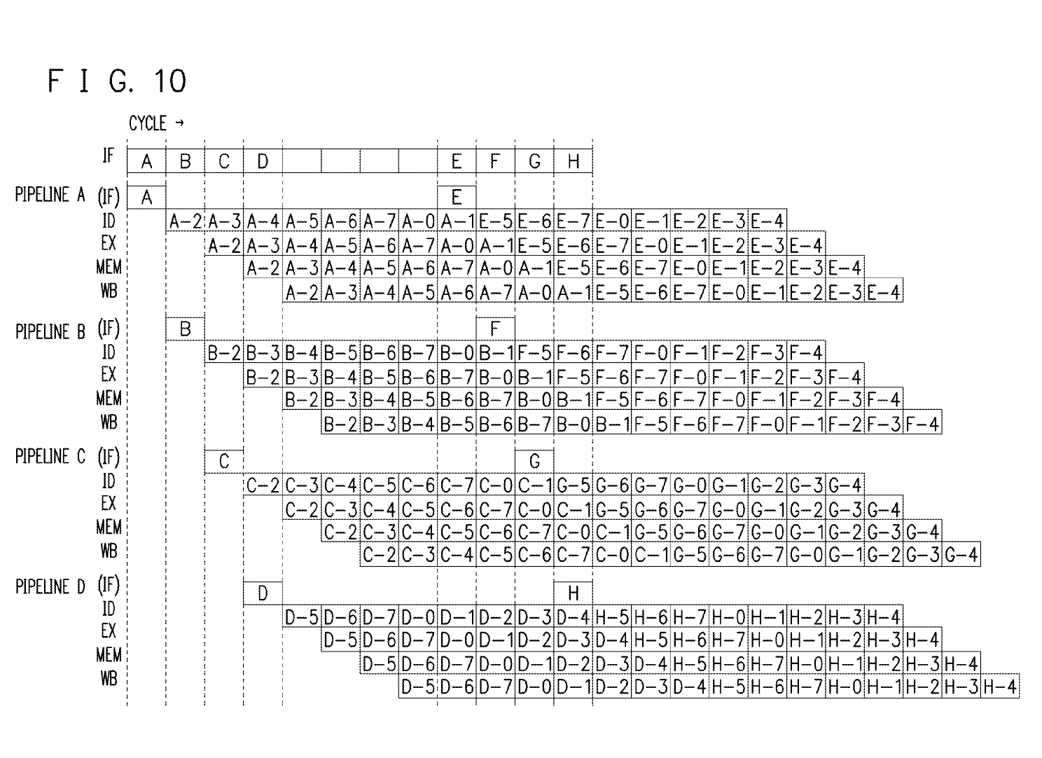

For example, even if the processing offset value is further changed in a state where the processing offset value has already been changed by the vector instruction executed before as illustrated in FIG. 10, in the case when the load instruction of the vector instruction A and the load instruction of the vector instruction D perform memory access to the same region in the data memory 110, there is no impact on the operation and the similar effect can be obtained.

Incidentally, in the above-described explanation, the vector processor with a five-stage pipeline configuration of the instruction fetch stage IF, the instruction decode stage ID, the arithmetic operation execution stage EX, the memory access stage MEM, and the write-back stage WB has been explained as an example, but the vector processor is not limited to this, and a vector processor with a pipeline configuration having a different stage number is also applicable. The number of execution pipelines that the vector processor includes is not also limited to four, and what is necessary is to have a plurality of execution pipelines.

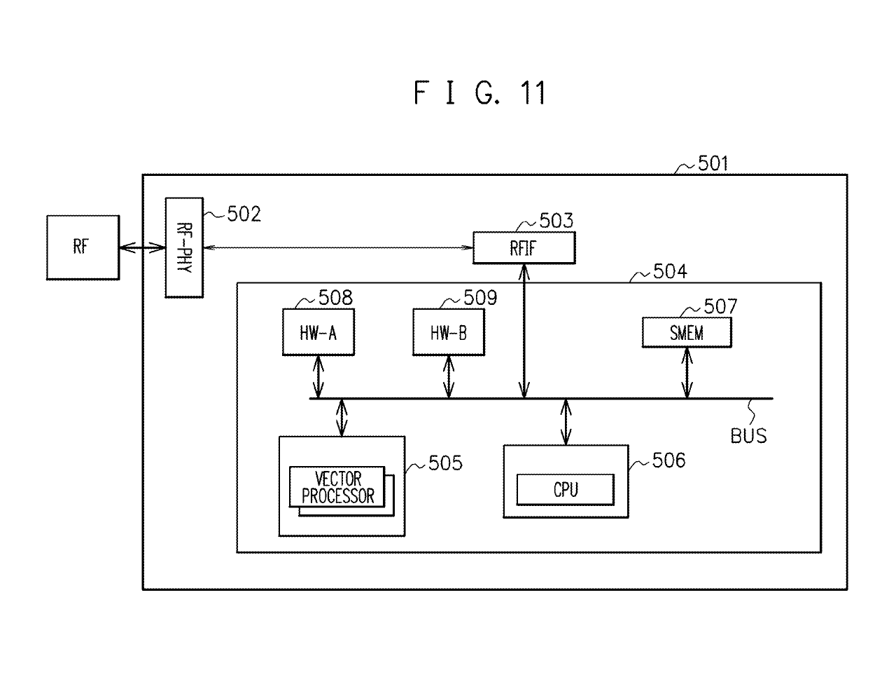

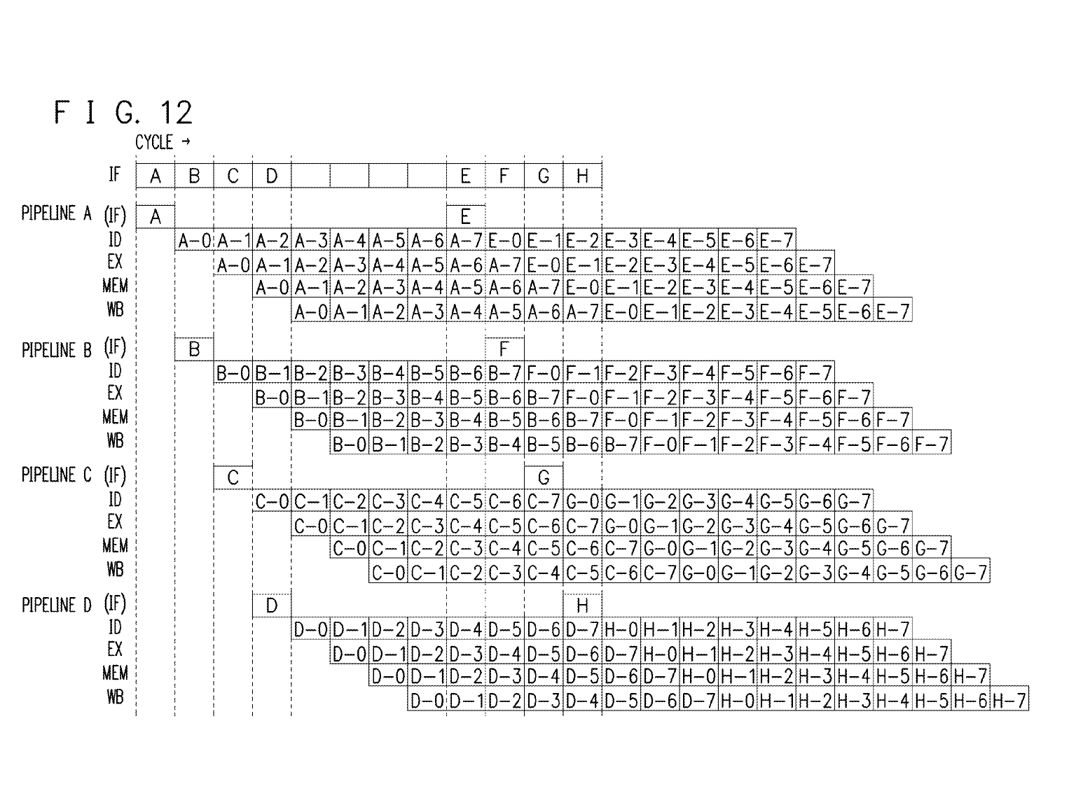

FIG. 11 is a view illustrating an example of a semiconductor integrated circuit including the processor (vector processor) in this embodiment. In FIG. 11, a semiconductor integrated circuit 501 having a baseband signal processing function in radio communication is illustrated as one example. The semiconductor integrated circuit 501 includes: a PHY unit (physical unit) 502; an interface unit 503; and a baseband processing unit 504. An RF baseband signal is supplied to the baseband processing unit 504 via the PHY unit 502 and the interface unit 503.

The baseband processing unit 504 includes: a modem 505 including the vector processor in this embodiment; a modem 506 including a scalar processor (CPU); a memory 507 that stores data and the like used for respective processings including baseband signal processing; and hardwares 508 and 509 that realize other processing functions. The respective functional units that the baseband processing unit 504 includes are connected to be able to communicate via a bus BUS.

FIG. 11 illustrates the example applying the processor (vector processor) in this embodiment to the semiconductor integrated circuit that performs baseband signal processing in radio communication, but the processor is not limited to this. The processor (vector processor) in this embodiment is also applicable to a semiconductor integrated circuit that performs, for example, image processing, and the like.

Regarding the disclosed processor, when there are memory accesses to the same data in a plurality of pipelines, repetition of memory access can be eliminated to decrease the number of times of memory access, resulting in that it is possible to improve memory access efficiency and decrease power consumption.

It should be noted that the above embodiments merely illustrate concrete examples of implementing the present invention, and the technical scope of the present invention is not to be construed in a restrictive manner by these embodiments. That is, the present invention may be implemented in various forms without departing from the technical spirit or main features thereof.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A processor, comprising:
a plurality of pipelines configured to pipeline-process vector instructions including load instructions for reading data from a memory, the plurality of pipelines including a first pipeline and a second pipeline;
an instruction issuance controller configured to decode a vector instruction read out from an instruction memory and issue the vector instruction to the pipeline; and
a controller, when the instruction issuance controller issues a first load instruction with respect to a first region of a memory to the first pipeline and a second load instruction with respect to the first region of the memory is being processed in the second pipeline, configured to determine an offset value according to a number of cycles that have been processed already in the second load instruction so that an access address of the first load instruction to the memory matches an access address of the second load instruction to the memory, and change a processing order in the first load instruction in the first pipeline on the basis of the offset value.

2. The processor according to claim 1, wherein
each of the pipelines includes a sequencer that includes a counter and is configured to control a processing order in the vector instruction on the basis of a count value of the counter, and
the controller is configured to set a count value of a counter of the sequencer that the second pipeline includes to the offset value.

3. The processor according to claim 1, wherein
the controller includes a register configured to hold the offset value, and is configured to change a processing order in the vector instruction on the basis of the offset value with respect to each of vector instructions to be issued after issuance of the first load instruction.

4. The processor according to claim 1, wherein
the controller includes:
an instruction detector configured to detect whether or not a vector instruction to be issued to the first pipeline and a vector instruction being processed in the second pipeline are the load instruction; and
a comparator configured to compare whether or not the vector instruction to be issued to the first pipeline and the vector instruction being processed in the second pipeline are matched with a base address of an access address to the memory, the access address being specified by the vector instructions when the vector instructions are the load instruction.

5. The processor according to claim 1, wherein
when the second load instruction is being processed in the second pipeline, the first pipeline does not perform access to the memory and takes in, as data of the first load instruction, data taken in by access to the memory by the second pipeline and when processing of the second load instruction in the second pipeline is finished, the first pipeline performs access to the memory according to the first load instruction to take in data.

6. A semiconductor integrated circuit, comprising:
a memory configured to store data; and
a processor configured to perform access to the memory, wherein
the processor includes:
a plurality of pipelines configured to pipeline-process vector instructions including load instructions for reading data from the memory, the plurality of pipelines including a first pipeline and a second pipeline;
an instruction issuance controller configured to decode a vector instruction read out from an instruction memory and issue the vector instruction to the pipeline; and
a controller, when the instruction issuance controller issues a first load instruction with respect to a first region of a memory to the first pipeline and a second load instruction with respect to the first region of the memory is being processed in the second pipeline, configured to determine an offset value according to a number of cycles that have been processed already in the second load instruction so that an access address of the first load instruction to the memory matches an access address of the second load instruction to the memory, and change a processing order in the first load instruction in the first pipeline on the basis of the offset value.

7. The semiconductor integrated circuit according to claim 6, wherein
each of the pipelines includes a sequencer that includes a counter and is configured to control a processing order in the vector instruction on the basis of a count value of the counter, and
the controller is configured to set a count value of a counter of the sequencer that the second pipeline includes to the offset value.

8. The semiconductor integrated circuit according to claim 6, wherein
the controller includes a register configured to hold the offset value, and is configured to change a processing order in the vector instruction on the basis of the offset value with respect to each of vector instructions to be issued after issuance of the first load instruction.

9. The semiconductor integrated circuit according to claim 6, wherein
the controller includes:
an instruction detector configured to detect whether or not a vector instruction to be issued to the first pipeline and a vector instruction being processed in the second pipeline are the load instruction; and
a comparator configured to compare whether or not the vector instruction to be issued to the first pipeline and the vector instruction being processed in the second pipeline are matched with a base address of an access address to the memory, the access address being specified by the vector instructions when the vector instructions are the load instruction.

10. The semiconductor integrated circuit according to claim 6, wherein
when the second load instruction is being processed in the second pipeline, the first pipeline does not perform access to the memory and takes in, as data of the first load instruction, data taken in by access to the memory by the second pipeline and when processing of the second load instruction in the second pipeline is finished, the first pipeline performs access to the memory according to the first load instruction to take in data.

11. A processing method of a vector instruction in a processor that includes a plurality of pipelines configured to pipeline-process vector instructions including load instructions for reading data from a memory, the plurality of pipelines including a first pipeline and a second pipeline, the processing method comprising:
decoding a vector instruction read out from an instruction memory and issuing the vector instruction to the pipeline;
judging whether or not a vector instruction to be issued to the first pipeline and a vector instruction being processed in the second pipeline are a load instruction;
judging whether or not the vector instruction to be issued to the first pipeline and the vector instruction being processed in the second pipeline are matched with a base address of an access address to the memory, the access address being specified by the vector instructions when the vector instructions are the load instruction; and
when the vector instruction to be issued to the first pipeline and the vector instruction being processed in the second pipeline are the load instruction and are matched with the base address of the access address, determining an offset value according to a number of cycles that have been processed already of the vector instruction in the second pipeline so that the access address based on the vector instruction to be issued to the first pipeline matches the access address based on the vector instruction being processed in the second pipeline, and changing a processing order in the vector instruction in the first pipeline on the basis of the offset value.

12. The processing method of the vector instruction according to claim 11, further comprising:
after changing the processing order in the vector instruction in the first pipeline on the basis of the offset value, with respect to each of succeeding vector instructions to be issued after issuance of the vector instruction to the first pipeline, changing a processing order in the succeeding vector instruction on the basis of the offset value.

13. The processing method of the vector instruction according to claim 11, wherein
when the vector instruction to be issued to the first pipeline and the vector instruction being processed in the second pipeline are the load instruction and are matched with the base address of the access address, taking in, as data of the vector instruction to be issued to the first pipeline, data taken in by access to the memory by the second pipeline without performing access to the memory by the first pipeline, and when processing of the vector instruction in the second pipeline is finished, performing access to the memory by the first pipeline according to the vector instruction to take in data.
